(19) United States
(12) Patent Application Publication
(10) Pub. No.: US 2025/0100637 A1
(43) Pub. Date: Mar. 27, 2025

(54) SADDLE CLAMP ASSEMBLY

(71) Applicant: Wolf Tooth Components, LLC, Burnsville, MN (US)

(72) Inventors: Michael W. Pfeiffer, Burnsville, MN (US); Robert Brown, Burnsville, MN (US)

(73) Assignee: Wolf Tooth Components, LLC, Burnsville, MN (US)

(21) Appl. No.: 18/892,134

(22) Filed: Sep. 20, 2024

Related U.S. Application Data
(60) Provisional application No. 63/539,811, filed on Sep. 21, 2023.

(51) Int. Cl. B62J 1/04; B62J 1/08

(52) U.S. Cl. CPC B62J 1/04; B62J 2001/085

(57) ABSTRACT

A saddle clamp assembly includes a lower cradle, an upper cradle supported by the lower cradle, and a left pivot block and a right pivot block each independently, rotatably coupled with the lower cradle, the left pivot block and the upper cradle, and the right pivot block and the upper cradle to secure a left saddle rail and a right saddle rail, respectively, of a saddle for a bicycle therebetween.

### CROSS-REFERENCE TO RELATED APPLICATIONS

This application claims priority under 35 U.S.C. 119 (e) to U.S. Provisional Patent Application Ser. No. 63/539,811 filed on Sep. 21, 2023, and incorporated herein by reference.

### BACKGROUND

The present disclosure relates generally to a saddle clamp assembly and, more specifically, relates to a saddle clamp assembly for a seat post, including a height adjustment seat post, for a saddle of a bicycle.

### BRIEF DESCRIPTION OF THE DRAWINGS

FIGS. 1, 2, 3, 4, 5, 6a, 6b, 6c, 7 illustrate an example of a saddle clamp assembly for a seat post in accordance with the present disclosure.

FIGS. 8a, 8b, 8c, 9 illustrate another example of a saddle clamp assembly for a seat post in accordance with the present disclosure.

FIGS. 10, 11a, 11b, 11c, 12 illustrate another example of a saddle clamp assembly for a seat post in accordance with the present disclosure.

FIGS. 13a, 13b, 13c, 13d, 13e, 13f, 13g, 14a, 14b, 14c, 14d illustrate an example of a portion of a saddle clamp assembly for a seat post in accordance with the present disclosure.

FIG. 15 illustrates an example implementation of a saddle clamp assembly for a seat post for a saddle of a bicycle in accordance with the present disclosure.

FIGS. 16, 17, 18 illustrate an example of a height adjustment seat post including a saddle clamp assembly in accordance with the present disclosure.

FIG. 19 illustrates an example implementation of a saddle clamp assembly for a height adjustment seat post for a saddle of a bicycle in accordance with the present disclosure.

FIGS. 20, 21 illustrate an example of a height adjustment seat post for a saddle of a bicycle including a saddle clamp assembly in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

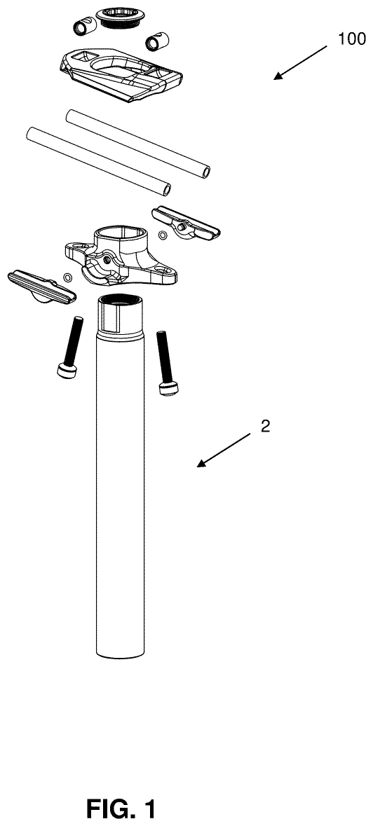

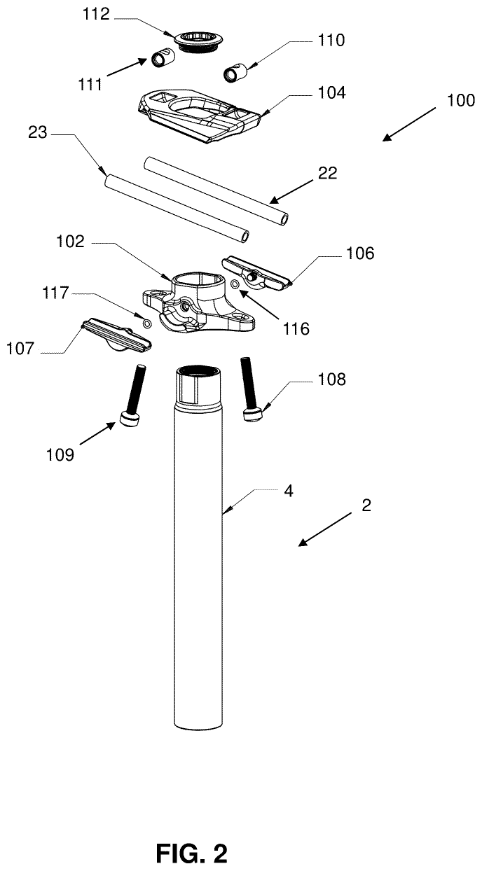

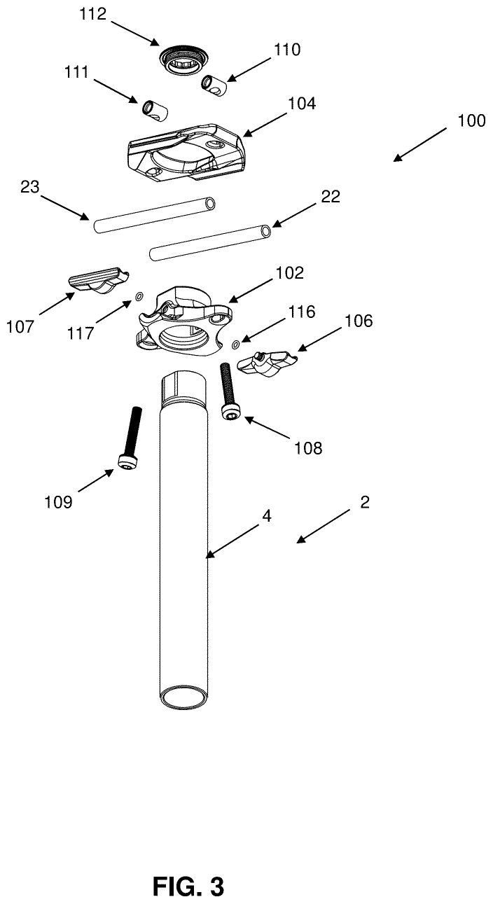

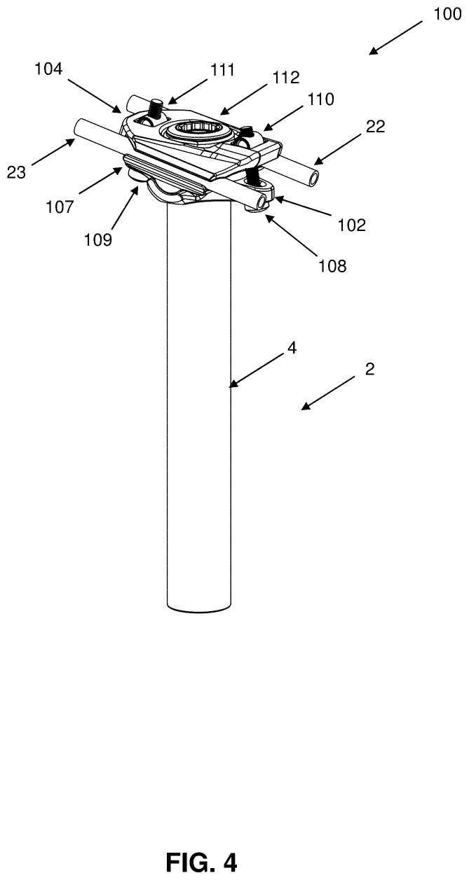

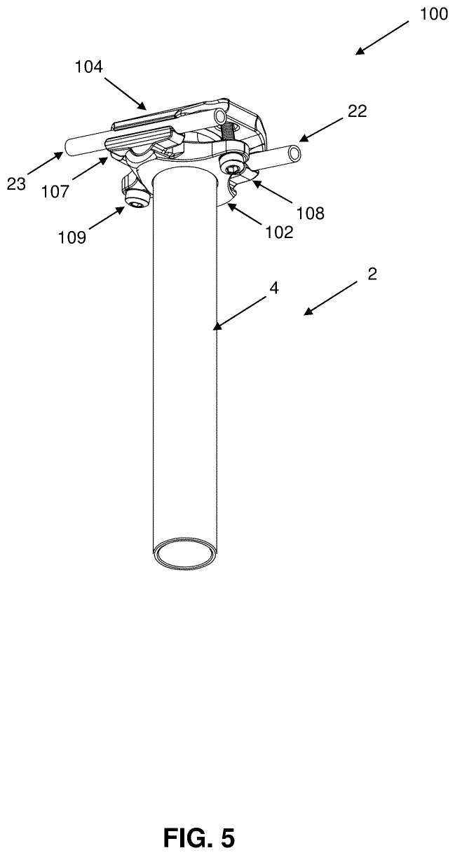

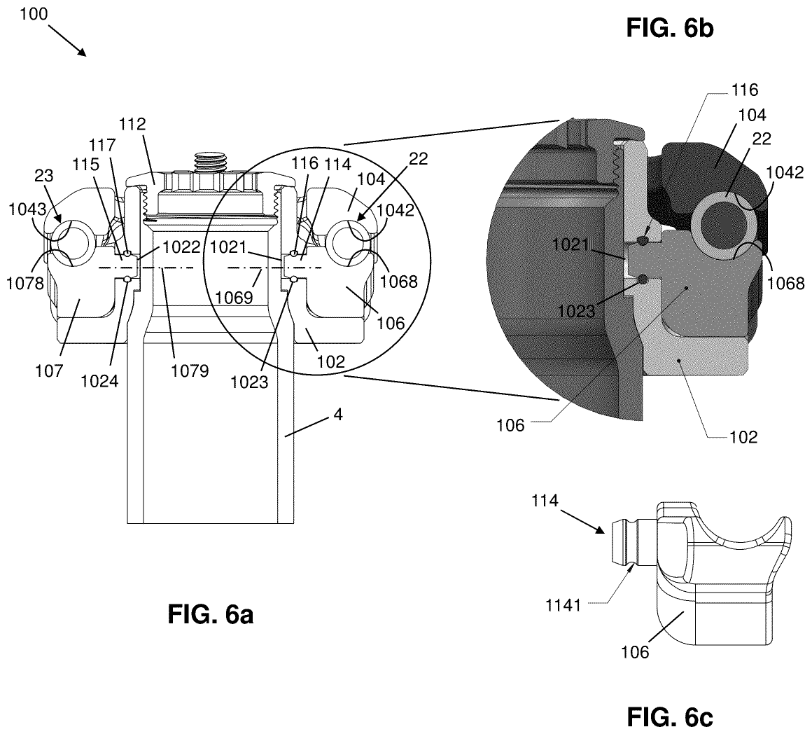

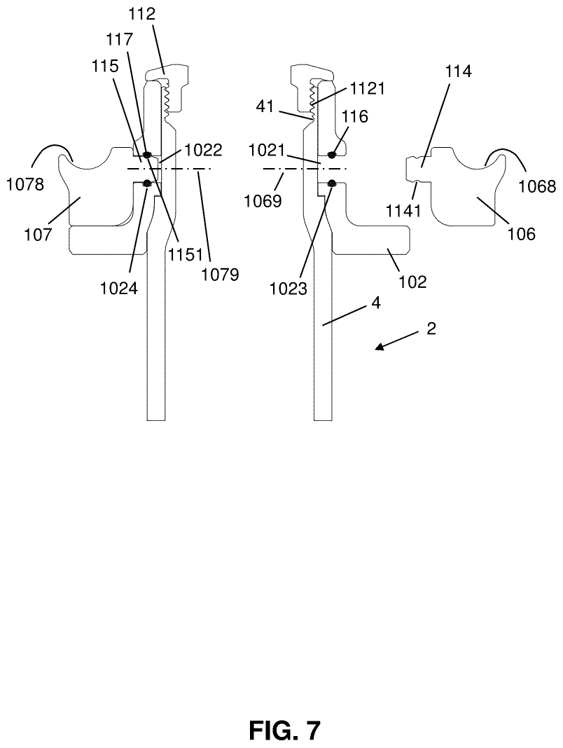

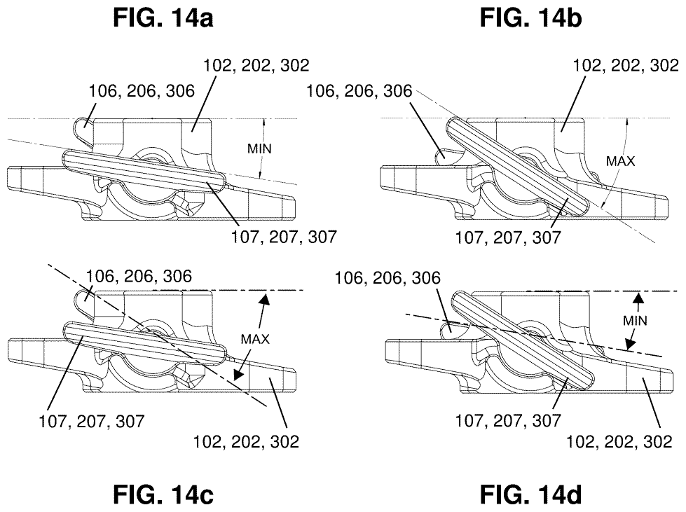

FIGS. 1, 2, 3, 4, 5, 6a, 6b, 60, 7 illustrate an example of a saddle clamp assembly 100 for a seat post 2 in accordance with the present disclosure. In examples, the saddle clamp assembly 100 includes a lower cradle 102, an upper cradle 104 supported by the lower cradle 102, and left and right pivot blocks 106, 107, respectively, independently, rotatably coupled with the lower cradle 102. In examples, the left and right pivot blocks 106, 107 are independently rotatable relative to the lower cradle 102 about a pivot axis 1069, 1079, respectively. (See also FIGS. 14a, 14b, 14c, 14d.)

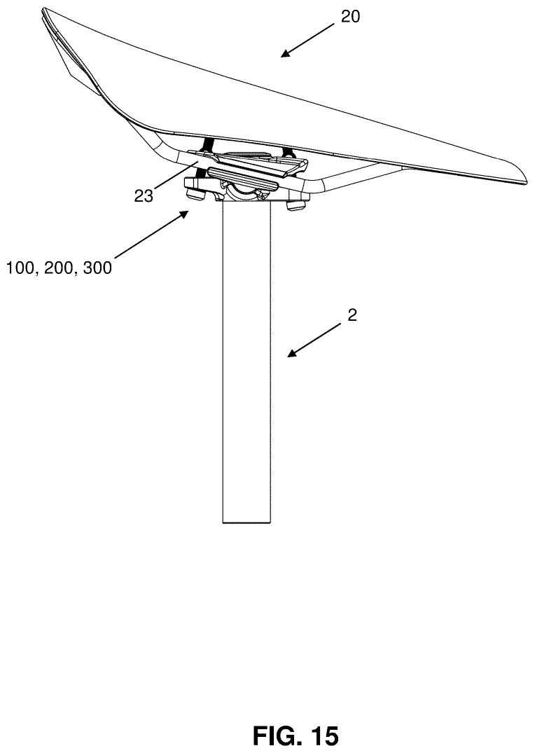

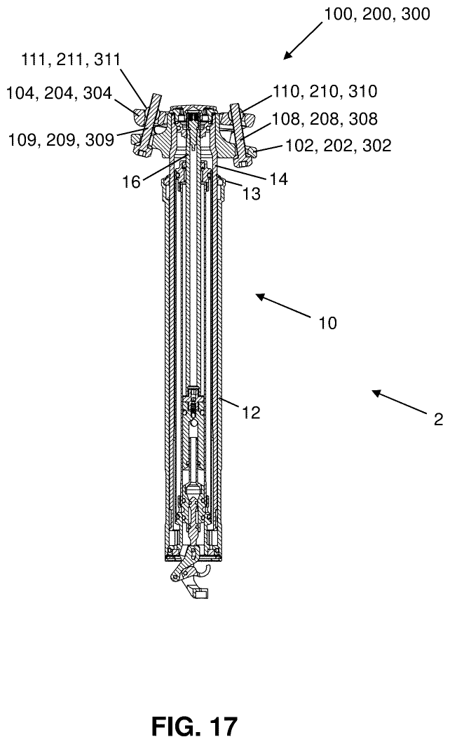

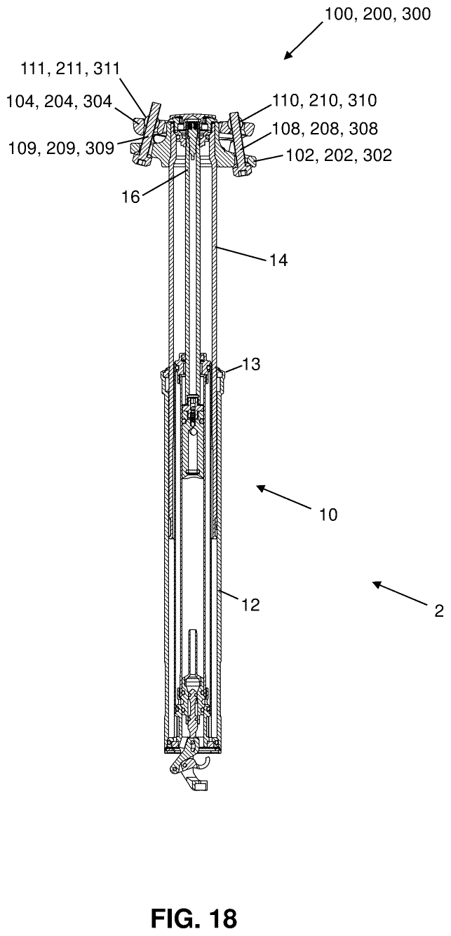

In examples, saddle clamp bolts 108, 109, respectively, extend through the lower cradle 102 and the upper cradle 104 and are threadably engaged with barrel nuts 110, 111, respectively, supported by the upper cradle 104 (see also FIGS. 17, 18) to couple the upper cradle 104 with the lower cradle 102 and secure left and right saddle rails 22, 23, respectively, of a saddle for a bicycle (such as, for example, the saddle 20 of FIG. 15) between the left and right pivot blocks 106, 107 and the upper cradle 104 (only a portion of the saddle rails 22, 23 being illustrated in FIGS. 1-5). In examples, tightening the saddle clamp bolts 108, 109 draws or pulls the upper cradle 104 toward the lower cradle 102 to secure the left and right saddle rails 22, 23 between the left and right pivot blocks 106, 107 and the upper cradle 104. In examples, the left and right pivot blocks 106, 107 include grooved channels 1068, 1078, respectively, and the upper cradle 104 includes grooved channels 1042, 1043, respectively, to support and secure the left and right saddle rails 22, 23.

In examples, a lock ring 112 secures the upper cradle 104 (as coupled with the lower cradle 102 by the saddle clamp bolts 108, 109 and the barrel nuts 110, 111) and the lower cradle 102 (with the left and right pivot blocks 106, 107) to an end of a stanchion 4, as an example of a portion of a seat post 2 for a bicycle. In examples, the lock ring 112 extends into the upper cradle 104, contacts the lower cradle 102, and includes threads 1121 to threadably engage with threads 41 in the end of the stanchion 4 to secure the upper cradle 104 and the lower cradle 102 to the end of the stanchion 4.

In examples, the left and right pivot blocks 106, 107 of the saddle clamp assembly 100 are each independently, rotatably secured to the lower cradle 102 by a cylindrical boss 114, 115, respectively, and a retaining ring 116, 117, respectively. In examples, the cylindrical boss 114, 115 extends from the pivot block 106, 107 and into a bore 1021, 1022, respectively, of the lower cradle 102, and the retaining ring 116, 117 provides a friction fit between the cylindrical boss 114, 115 and the lower cradle 102 within the bore 1021, 1022 to retain the pivot block 106, 107. In examples, the retaining ring 116, 117 is retained in an internal gland 1023, 1024, respectively, of the bore 1021, 1022 in the lower cradle 102, and a groove 1141, 1151, respectively, on the cylindrical boss 114, 115 of the pivot block 106, 107 engages the retaining ring 116, 117 to retain the pivot block 106, 107.

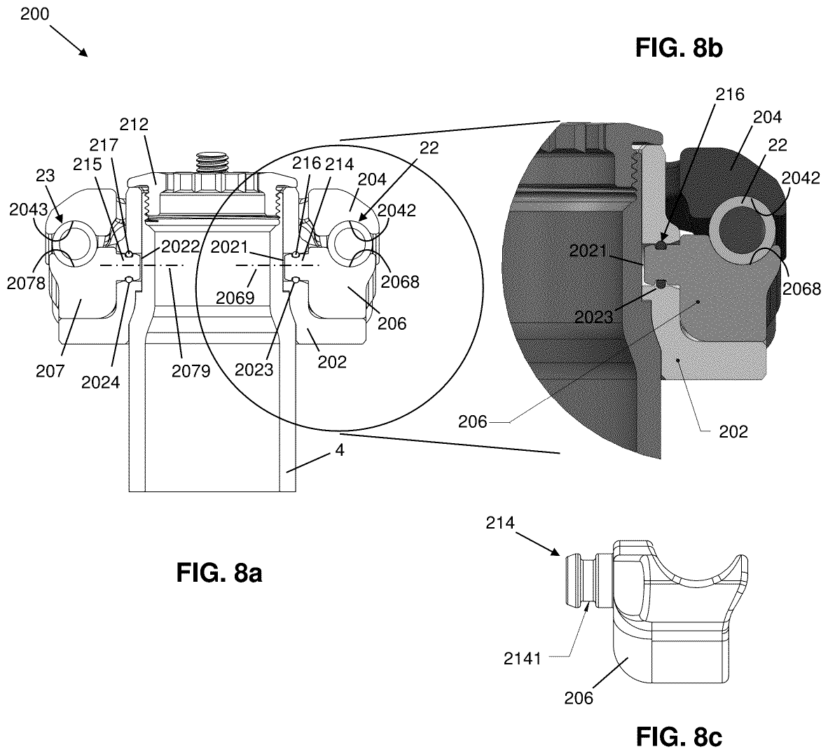

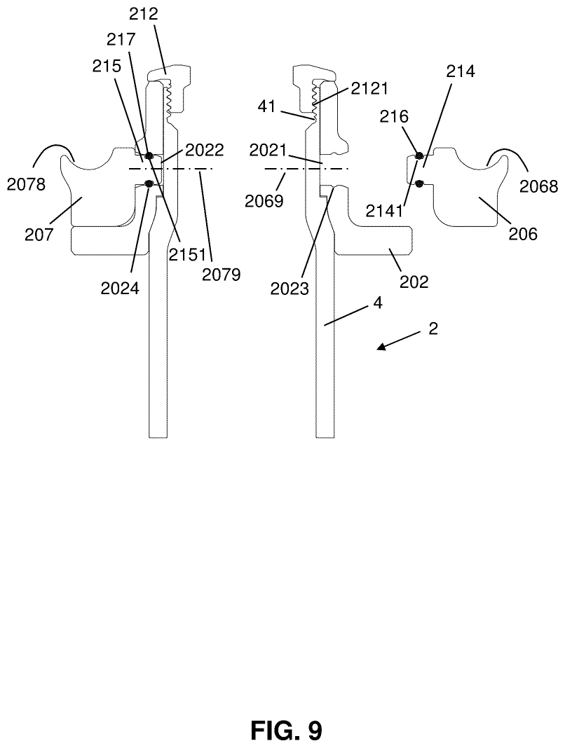

FIGS. 8a, 8b, 8c, 9 illustrate another example of a saddle clamp assembly 200 for a seat post 2 in accordance with the present disclosure. Similar to the saddle clamp assembly 100, in examples, the saddle clamp assembly 200 includes a lower cradle 202, an upper cradle 204 supported by the lower cradle 202, and left and right pivot blocks 206, 207, respectively, independently, rotatably coupled with the lower cradle 202. In examples, the left and right pivot blocks 206, 207 are independently rotatable relative to the lower cradle 202 about a pivot axis 2069, 2079, respectively. (See also FIGS. 14a, 14b, 14c, 14d.)

In examples, saddle clamp bolts (similar to the saddle clamp bolts 108, 109 of the saddle clamp assembly 100) extend through the lower cradle 202 and the upper cradle 204 and are threadably engaged with barrel nuts (similar to the barrel nuts 110, 111 of the saddle clamp assembly 100) supported by the upper cradle 204 to couple the upper cradle 204 with the lower cradle 202 and secure left and right saddle rails 22, 23, respectively, of a saddle for a bicycle (such as, for example, the saddle 20 of FIG. 15) between the left and right pivot blocks 206, 207 and the upper cradle 204. In examples, tightening the saddle clamp bolts draws or pulls the upper cradle 204 toward the lower cradle 202 to secure the left and right saddle rails 22, 23 between the left and right pivot blocks 206, 207 and the upper cradle 204. In examples, the left and right pivot blocks 206, 207 include grooved channels 2068, 2078, respectively, and the upper cradle 204 includes grooved channels 2042, 2043, respectively, to support and secure the left and right saddle rails 22, 23.

In examples, a lock ring 212 secures the upper cradle 204 (as coupled with the lower cradle 202 by the saddle clamp bolts and the barrel nuts) and the lower cradle 202 (with the left and right pivot blocks 206, 207) to an end of a stanchion 4, as an example of a portion of a seat post 2 for a bicycle. In examples, the lock ring 212 extends into the upper cradle 204, contacts the lower cradle 202, and includes threads 2121 to threadably engage with threads 41 in the end of the stanchion 4 to secure the upper cradle 204 and the lower cradle 202 to the end of the stanchion 4.

In examples, the left and right pivot blocks 206, 207 of the saddle clamp assembly 200 are each independently, rotatably secured to the lower cradle 202 by a cylindrical boss 214, 215, respectively, and a retaining ring 216, 217, respectively. In examples, the cylindrical boss 214, 215 extends from the pivot block 206, 207 and into a bore 2021, 2022, respectively, of the lower cradle 202, and the retaining ring 216, 217 provides a friction fit between the cylindrical boss 214, 215 and the lower cradle 202 within the bore 2021, 2022 to retain the pivot block 206, 207. In examples, the retaining ring 216, 217 is retained in an external gland 2141, 2151, respectively, on the cylindrical boss 214, 215 of the pivot block 206, 207, and a groove 2023, 2024, respectively, in the bore 2021, 2022 of the lower cradle 202 engages the retaining ring 216, 217 to retain the pivot block 206, 207.

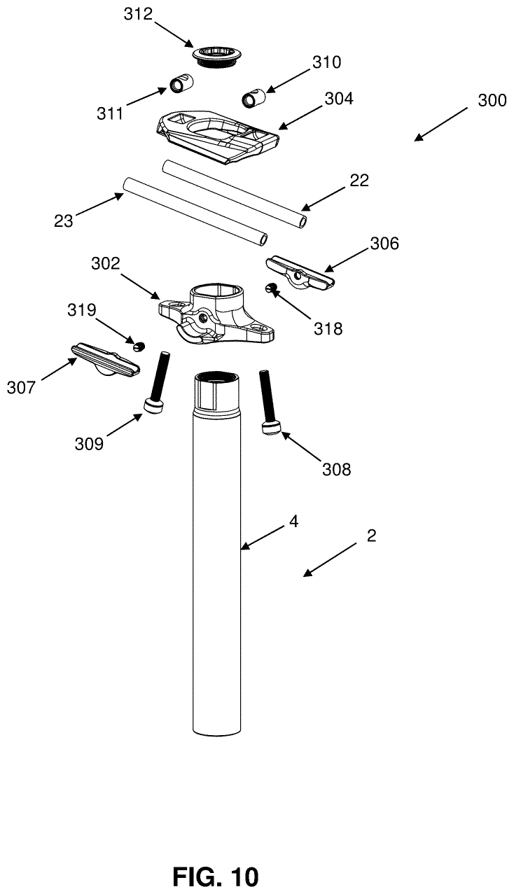

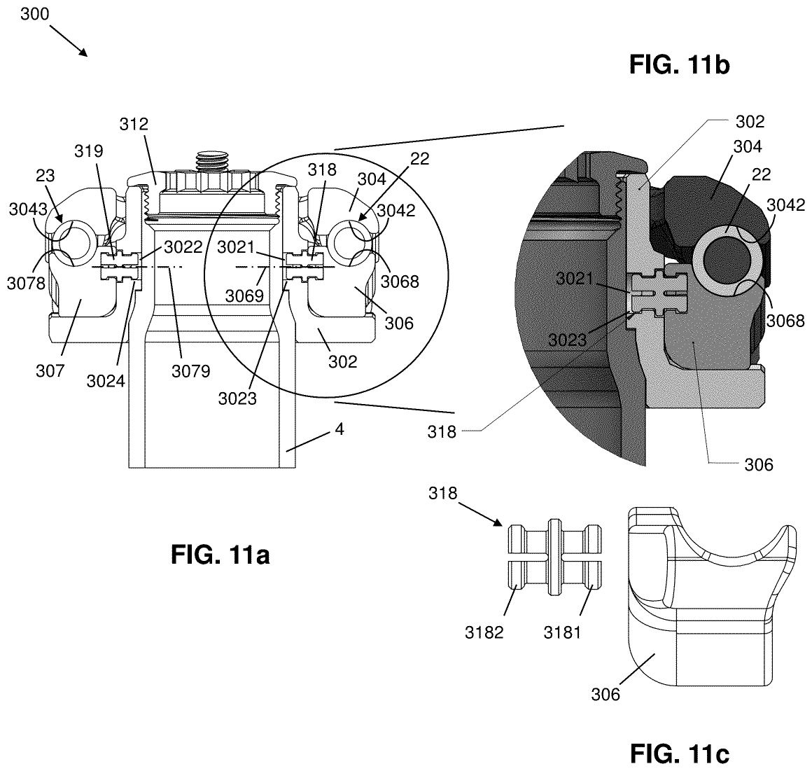

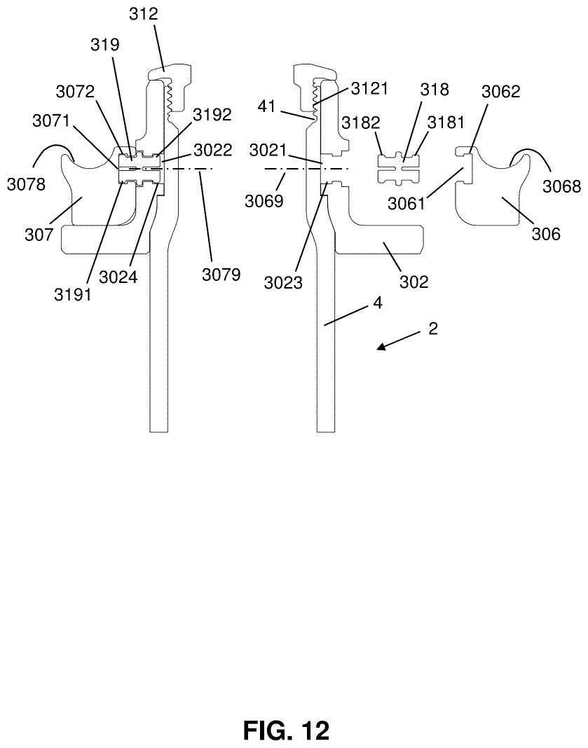

FIGS. 10, 11a, 11b, 11c, 12 illustrate another example of a saddle clamp assembly 300 for a seat post 2 in accordance with the present disclosure. Similar to the saddle clamp assembly 100, in examples, the saddle clamp assembly 300 includes a lower cradle 302, an upper cradle 304 supported by the lower cradle 302, and left and right pivot blocks 306, 307, respectively, independently, rotatably coupled with the lower cradle 302. In examples, the left and right pivot blocks 306, 307 are independently rotatable relative to the lower cradle 302 about a pivot axis 3069, 3079, respectively. (See also FIGS. 14a, 14b, 14c, 14d.)

In examples, saddle clamp bolts 308, 309, respectively, (similar to the saddle clamp bolts 108, 109 of the saddle clamp assembly 100) extend through the lower cradle 302 and the upper cradle 304 and are threadably engaged with barrel nuts 310, 311, respectively, (similar to the barrel nuts 110, 111 of the saddle clamp assembly 100) supported by the upper cradle 304 to couple the upper cradle 304 with the lower cradle 302 and secure left and right saddle rails 22, 23, respectively, of a saddle for a bicycle (such as, for example, the saddle 20 of FIG. 15) between the left and right pivot blocks 306, 307 and the upper cradle 304 (only a portion of the saddle rails 22, 23 being illustrated in FIG. 10). In examples, tightening the saddle clamp bolts 308, 309 draws or pulls the upper cradle 304 toward the lower cradle 302 to secure the left and right saddle rails 22, 23 between the left and right pivot blocks 306, 307 and the upper cradle 304. In examples, the left and right pivot blocks 306, 307 include grooved channels 3068, 3078, respectively, and the upper cradle 304 includes grooved channels 3042, 3043, respectively, to support and secure the left and right saddle rails 22, 23.

In examples, a lock ring 312 secures the upper cradle 304 (as coupled with the lower cradle 302 by the saddle clamp bolts 308, 309 and the barrel nuts 310, 311) and the lower cradle 302 (with the left and right pivot blocks 306, 307) to an end of a stanchion 4, as an example of a portion of a seat post 2 for a bicycle. In examples, the lock ring 312 extends into the upper cradle 304, contacts the lower cradle 302, and includes threads 3121 to threadably engage with threads 41 in the end of the stanchion 4 to secure the upper cradle 304 and the lower cradle 302 to the end of the stanchion 4.

In examples, the left and right pivot blocks 306, 307 of the saddle clamp assembly 300 are each independently, rotatably secured to the lower cradle 302 by a pivot pin 318, 319, respectively. In examples, one end of the pivot pin 318, 319 extends into a bore 3061, 3071, respectively, of the pivot block 306, 307 and another end of the pivot pin 318, 319 extends into a bore 3021, 3022, respectively, of the lower cradle 302 to retain the pivot block 306, 307. In examples, a lip 3181, 3191, respectively, at the one end of the pivot pin 318, 319 is retained in a groove 3062, 3072, respectively, of the bore 3061, 3071 in the pivot block 306, 307, and a lip 3182, 3192, respectively, at the other end of the pivot pin 318, 319 is retained in a groove 3023, 3024, respectively, of the bore 3021, 3022 in the lower cradle 302 to retain the pivot block 306, 307.

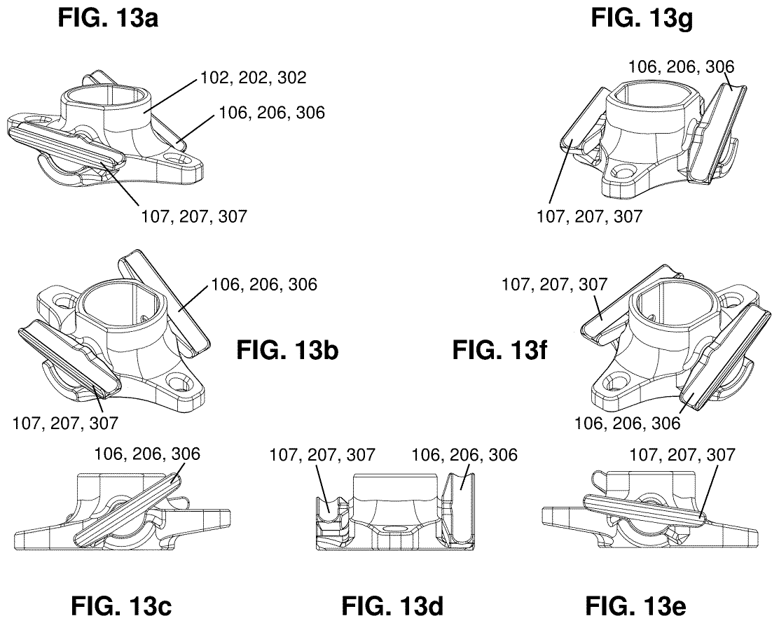

FIGS. 13a, 13b, 13c, 13d, 13e, 13f, 13g, 14a, 14b, 14c, 14d illustrate an example of a portion of a saddle clamp assembly for a seat post in accordance with the present disclosure, such as, for example, the saddle clamp assembly 100, the saddle clamp assembly 200, the saddle clamp assembly 300. In examples, the left and right pivot blocks, such as, for example, the pivot blocks 106, 107, the pivot blocks 206, 207, the pivot blocks 306, 307, respectively, of the saddle clamp assembly 100, 200, 300 are independently, rotatably adjustable between a minimum angle and a maximum angle (relative to a reference plane of the lower cradle 102, 202, 302). In examples, the minimum angle is in a range of 5 degrees to 10 degrees, and the maximum angle is in a range of 30 degrees to 35 degrees. In examples, the minimum angle is in a range of 8 degrees to 9 degrees, and the maximum angle is in a range of 32 degrees to 33 degrees.

FIG. 15 illustrates an example implementation of a saddle clamp assembly for a seat post 2 for a saddle 20 of a bicycle in accordance with the present disclosure, such as, for example, the saddle clamp assembly 100, the saddle clamp assembly 200, the saddle clamp assembly 300.

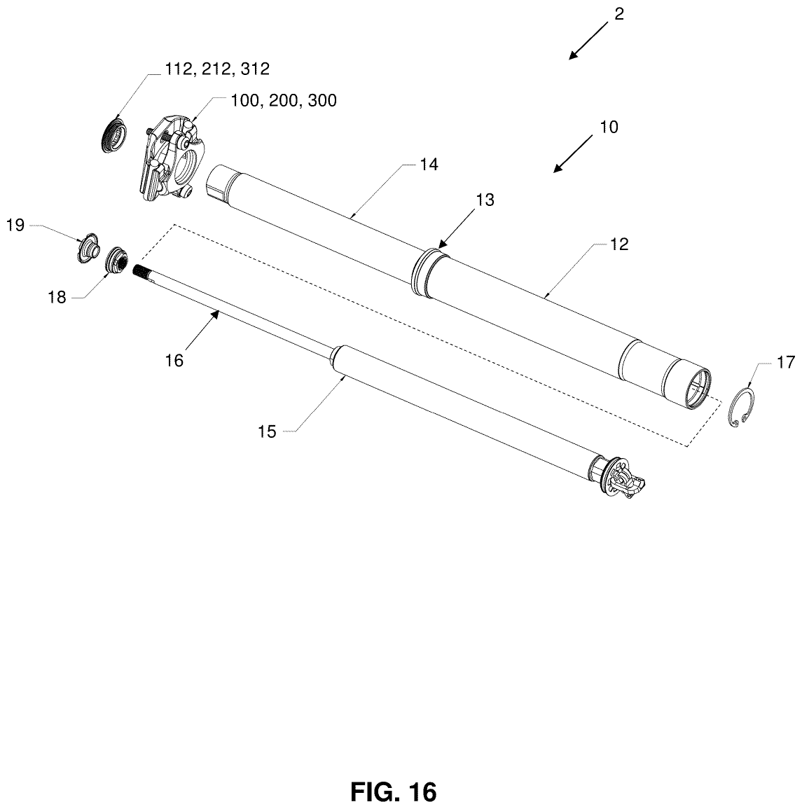

FIGS. 16, 17, 18 illustrate an example of a height adjustment seat post 10, as an example of a seat post 2 for a saddle 20 of a bicycle, in accordance with the present disclosure. In examples, the height adjustment seat post 10 includes a lower housing (lower tube) 12, a stanchion 14 telescopically supported within the lower housing 12, a cartridge 15 (including a piston rod 16) supported within the lower housing 12 and the stanchion 14 to telescopically adjust the stanchion 14 relative to the lower housing 12, and a saddle clamp assembly, such as, for example, the saddle clamp assembly 100, the saddle clamp assembly 200, the saddle clamp assembly 300, to be secured (removably secured) to the stanchion 14, for example, by the lock ring 112, the lock ring 212, the lock ring 312, respectively, to support a saddle (such as, for example, the saddle 20 of FIG. 15) for a bicycle. In examples, an end of the cartridge 15 is retained within the lower housing 12 by a snap ring 17, and an end of the piston rod 16 is secured to an end of the stanchion 14 by an upper cap 18. In examples, an air cap 19 covers the end of the height adjustment seat post 10.

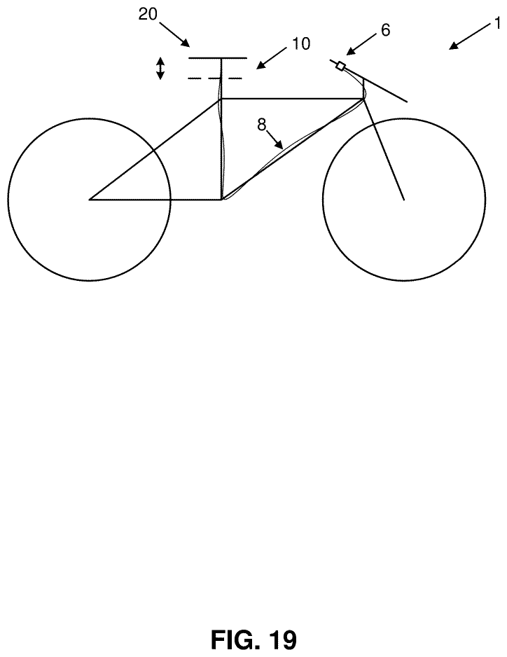

FIG. 19 illustrates an example implementation of a saddle clamp assembly for a height adjustment seat post for a saddle of a bicycle 1 in accordance with the present disclosure, such as, for example, the height adjustment seat post 10 for the saddle 20. In examples, a control device 6 may be mounted on a bicycle (e.g., a handlebar of a bicycle), such that operation or actuation of the control device 6 may be used to apply pull to an actuation or control cable 8 coupled with a height adjustment seat post for a saddle of a bicycle, such as, for example, the height adjustment seat post 10 for the saddle 20. In examples, the height adjustment seat post includes a saddle clamp assembly in accordance with the present disclosure, such as, for example, the saddle clamp assembly 100, the saddle clamp assembly 200, the saddle clamp assembly 300.

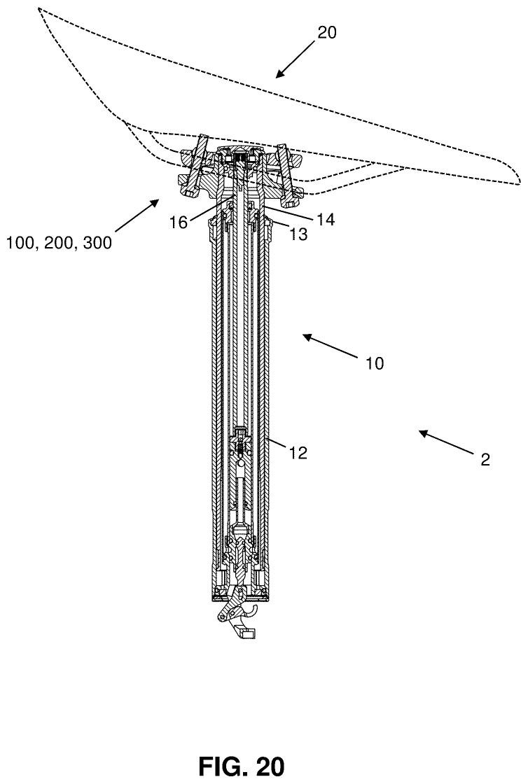

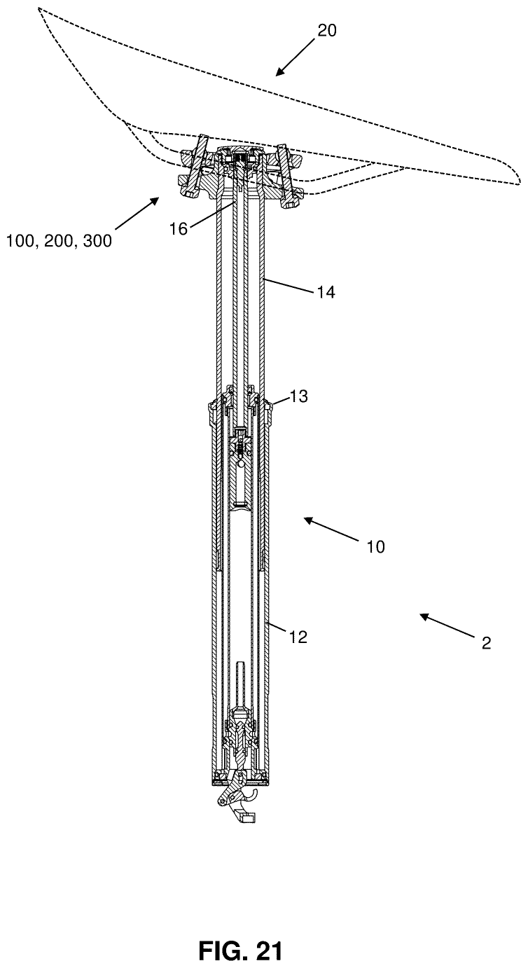

FIGS. 20, 21 illustrate an example of a height adjustment seat post for a saddle of a bicycle including a saddle clamp assembly in accordance with the present disclosure, such as, for example, the height adjustment seat post 10 for the saddle 20 including the saddle clamp assembly 100, the saddle clamp assembly 200, the saddle clamp assembly 300.

A saddle clamp assembly as disclosed herein, such as, for example, the saddle clamp assembly 100, the saddle clamp assembly 200, the saddle clamp assembly 300, provides a low stack height for a height adjustment seat post for a saddle of a bicycle, such as, for example, the height adjustment seat post 10. More specifically, as illustrated in the example of FIGS. 20, 21, with the stanchion 14 of the height adjustment seat post 10 extended into the lower cradle 102, 202, 302 of the saddle clamp assembly 100, 200, 300, and the left and right pivot blocks (separate, independently pivotable pivot blocks), such as, for example, the pivot blocks 106, 107, the pivot blocks 206, 207, the pivot blocks 306, 307, respectively, of the saddle clamp assembly 100, 200, 300 positioned on opposite sides of the lower cradle 102, 202, 302, pivot axes 1069, 1079, 2069, 2079, 3069, 3079 of the pivot blocks 106, 107, 206, 207, 306, 307 are positioned outboard or laterally of an interface of the lower cradle 102, 202, 302 with the stanchion 14. As such, the cartridge 15 and the piston rod 16 (as extended from the cartridge 15 within the stanchion 14) of the height adjustment seat post 10 can extend into and/or pass through the lower cradle 102, 202, 302 of the saddle clamp assembly 100, 200, 300. Thus, in examples, with a saddle, such as, for example, the saddle 20, supported by a saddle clamp assembly as disclosed herein, such as, for example, the saddle clamp assembly 100, the saddle clamp assembly 200, the saddle clamp assembly 300, a supported length of the saddle rails, such as, for example, the saddle rails 22, 23, is positioned outboard or laterally of the interface of the lower cradle 102, 202, 302 with the stanchion 14. Accordingly, a low stack height (as measured, for example, between a collar 13 of the lower housing 12 and a position of the supported length of the saddle rails 22, 23 when the height adjustment seat post 10 is fully compressed) is achieved. A lower stack height enables the saddle, such as, for example, the saddle 20, to be as low as possible when the height adjustment seat post 10 is fully compressed. Thus, a total length of adjustment between fully extended and fully compressed positions (travel) of the height adjustment seat post 10 is maximized.

Although the lower cradle of the saddle clamp assembly, such as, for example, the lower cradle 102 of the saddle clamp assembly 100, the lower cradle 202 of the saddle clamp assembly 200, the lower cradle 302 of the saddle clamp assembly 300, is illustrated in examples as being formed separately from and removably secured to the stanchion, such as, for example, the stanchion 14, in other examples, the lower cradle is formed integrally with the stanchion.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A saddle clamp assembly, comprising:
a lower cradle;
an upper cradle supported by the lower cradle; and
a left pivot block and a right pivot block each independently, rotatably coupled with the lower cradle,
the left pivot block and the upper cradle, and the right pivot block and the upper cradle to secure a left saddle rail and a right saddle rail, respectively, of a saddle for a bicycle therebetween.

2. The saddle clamp assembly of claim 1, wherein:
the left pivot block and the right block each independently rotatable relative to the lower cradle about a pivot axis, the pivot axis of the left pivot block and the pivot axis of the right pivot block positioned on opposite sides of the lower cradle.

3. The saddle clamp assembly of claim 1, wherein:
the lower cradle to have a portion of a seat post extended thereinto at an interface.

4. The saddle clamp assembly of claim 3, wherein:
a supported length of each the left saddle rail and the right saddle rail to be positioned outboard of the interface.

5. The saddle clamp assembly of claim 3, further comprising:
a lock ring to secure the upper cradle and the lower cradle to an end of the seat post.

6. The saddle clamp assembly of claim 3, wherein:
the seat post comprising a height adjustment seat post, and the portion of the seat post comprising a stanchion of the height adjustment seat post.

7. The saddle clamp assembly of claim 1, wherein:
the left pivot block and the right pivot block each independently, rotatably adjustable relative to the lower cradle between a minimum angle in a range of 5 degrees to 10 degrees and a maximum angle in a range of 30 degrees to 35 degrees.

8. The saddle clamp assembly of claim 1, further comprising:
a saddle clamp bolt extended through the lower cradle and the upper cradle; and
a barrel nut supported by the upper cradle,
the saddle clamp bolt threadably engaged with the barrel nut to couple the upper cradle with the lower cradle and secure the left saddle rail and the right side rail between the left pivot block and the upper cradle, and the right pivot block and the upper cradle, respectively.

9. The saddle clamp assembly of claim 1, wherein:
the left pivot block and the right pivot block each having a cylindrical boss extended therefrom, the cylindrical boss to extend into a respective bore of the lower cradle, and further comprising:
a retaining ring to provide a friction fit between the cylindrical boss and the lower cradle within the respective bore.

10. The saddle clamp assembly of claim 1, further comprising:
the left pivot block and the right pivot block each independently, rotatably secured to the lower cradle by a respective pivot pin, one end of the respective pivot pin extended into a respective bore of the left pivot block and the right pivot block, and another end of the respective pivot pin extended into a respective bore of the lower cradle.

11. A saddle clamp assembly for a height adjustment seat post for a saddle of a bicycle, the saddle clamp assembly comprising:
a lower cradle;
an upper cradle coupled with the lower cradle; and
a left pivot block and a right pivot block each independently rotatable relative to the lower cradle,
the left pivot block to support a left saddle rail of the saddle and the right pivot block to support a right saddle rail of the saddle,
the left saddle rail to be secured between the left pivot block and the upper cradle, and the right saddle rail to be secured between the right pivot block and the upper cradle.

12. The saddle clamp assembly of claim 11, wherein:
the lower cradle to have a stanchion of the height adjustment seat post extended thereinto at an interface.

13. The saddle clamp assembly of claim 12, wherein:
the left pivot block and the right block each independently rotatable relative to the lower cradle about a pivot axis, the pivot axis to be positioned laterally of the interface of the lower cradle with the stanchion.

14. The saddle clamp assembly of claim 12, wherein:
a supported length of each the left saddle rail and the right saddle rail to be positioned laterally of the interface of the lower cradle with the stanchion.

15. The saddle clamp assembly of claim 11, wherein:
a piston rod of the height adjustment seat post to extend into the lower cradle.

16. The saddle clamp assembly of claim 11, further comprising:
a lock ring to secure the upper cradle and the lower cradle to an end of the height adjustment seat post.

17. The saddle clamp assembly of claim 11, wherein:
the left pivot block and the right pivot block each independently, rotatably adjustable relative to the lower cradle between a minimum angle in a range of 5 degrees to 10 degrees and a maximum angle in a range of 30 degrees to 35 degrees.

18. The saddle clamp assembly of claim 11, further comprising:
a saddle clamp bolt extended through the lower cradle and the upper cradle; and
a barrel nut supported by the upper cradle,
the saddle clamp bolt threadably engaged with the barrel nut to couple the upper cradle with the lower cradle and secure the left saddle rail and the right side rail between the left pivot block and the upper cradle, and the right pivot block and the upper cradle, respectively.

19. The saddle clamp assembly of claim 11, wherein:
the left pivot block and the right pivot block each having a cylindrical boss extended therefrom, the cylindrical boss to extend into a respective bore of the lower cradle, and further comprising:
a retaining ring to provide a friction fit between the cylindrical boss and the lower cradle within the respective bore.

20. The saddle clamp assembly of claim 11, further comprising:
the left pivot block and the right pivot block each independently, rotatably secured to the lower cradle by a respective pivot pin, one end of the respective pivot pin extended into a respective bore of the left pivot block and the right pivot block, and another end of the respective pivot pin extended into a respective bore of the lower cradle.
